(19) United States
(12) Patent Application Publication
(10) Pub. No.: US 2025/0387926 A1
(43) Pub. Date: Dec. 25, 2025

(54) PICK AND PLACE END EFFECTOR

(71) Applicant: The Boeing Company, Arlington, VA (US)

(72) Inventor: Nayeem Tawqir Chowdhury, Melbourne (AU)

(21) Appl. No.: 18/750,755

(22) Filed: Jun. 21, 2024

(51) Int. Cl. B25J 15/06; B25J 15/00

(52) U.S. Cl. CPC B25J 15/0616; B25J 15/0085

(57) ABSTRACT

An end effector configured to lift composite material through two different mechanisms and methods of picking and placing composite material are presented. The end effector comprises a vacuum end effector with a plurality of vacuum pogos configured to pick and place a composite preform in contact with the plurality of vacuum pogos, and an electrostatic membrane configured to be removably held by the plurality of vacuum pogos and pick and place a single ply composite material while the electrostatic membrane is held by the plurality of vacuum pogos.

### BACKGROUND INFORMATION

### 1. Field

The present disclosure relates generally to an end effector and more specifically to a pick and place end effector configured to use two different lift mechanisms.

### 2. Background

During composite manufacturing, composite plies are laid up and then transported either as single plies or as a stack of a plurality of composite plies. If hand layup is used, a technician places each individual ply on a substrate at a precise location relative to other plies. Hand layup utilizes ply by ply placement. Placement of the plies is limited in size by what size the technician can handle.

If an automated layup is performed, a pick and place end effector can be used to transport the composite material. However, different end effectors may be used for at least one of different types of composite material, different thicknesses of composite material, different shapes of composite material, or other differences. Removing, connecting, and aligning different end effectors can be undesirably time-consuming.

Therefore, it would be desirable to have a method and apparatus that takes into account at least some of the issues discussed above, as well as other possible issues. For example, it may be desirable to reduce the time of picking and placing composite material.

### SUMMARY

An embodiment of the present disclosure provides an end effector configured to lift composite material through two different mechanisms. The end effector comprises a vacuum end effector with a plurality of vacuum pogos configured to pick and place a composite preform in contact with the plurality of vacuum pogos, and an electrostatic membrane configured to be removably held by the plurality of vacuum pogos and pick and place a single ply composite material while the electrostatic membrane is held by the plurality of vacuum pogos.

Another embodiment of the present disclosure provides a method of picking and placing composite material using a single end effector with two different mechanisms. A single ply composite material is picked and placed using an electrostatic membrane held by a plurality of vacuum pogos of a vacuum end effector. The electrostatic membrane is released from the vacuum end effector. A composite preform is picked and placed using the plurality of vacuum pogos.

Yet another embodiment of the present disclosure provides a method of picking and placing composite material using a single end effector with two different mechanisms. A curvature is formed into a composite preform held using vacuum holding from a vacuum end effector. A curvature is formed into a single ply composite material held using electrostatic force from an electrostatic membrane held by the vacuum end effector.

A further embodiment of the present disclosure provides a method of picking and placing composite material using a single end effector with two different mechanisms. Single plies of composite material are repeatedly placed using an electrostatic membrane held by a plurality of vacuum pogos of a vacuum end effector to form a stack of composite plies. The electrostatic membrane is released from the vacuum end effector. The stack of composite plies is lifted using the plurality of vacuum pogos.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a side view of an electrostatic end effector in accordance with an illustrative embodiment;

FIG. 4 is an illustration of a side view of a vacuum end effector pulling vacuum to connect an electrostatic membrane in accordance with an illustrative embodiment;

FIG. 5 is an illustration of a side view of a vacuum end effector picking and placing a composite preform in accordance with an illustrative embodiment;

FIG. 6 is an illustration of a side view of an electrostatic end effector picking and placing a composite ply in accordance with an illustrative embodiment;

FIG. 7 is a flowchart of a method of picking and placing composite material using a single end effector with two different mechanisms in accordance with an illustrative embodiment;

FIG. 8 is a flowchart of a method of picking and placing composite material using a single end effector with two different mechanisms in accordance with an illustrative embodiment;

FIG. 9 is a flowchart of a method of picking and placing composite material using a single end effector with two different mechanisms in accordance with an illustrative embodiment;

FIG. 10 is an illustration of an aircraft manufacturing and service method in a form of a block diagram in accordance with an illustrative embodiment; and

FIG. 11 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that three-dimensional pick and place, also referred to as 3D Pick and Place (3D PnP) is the process of placing flat plies cut from a roll of fabric onto a curved tool. The fabric can be either pre-impregnated composite material (prepreg) or dry fabric.

The illustrative embodiments recognize and take into account that in an automated layup environment of dry carbon fabric in resin infusion applications, the pick and place end effector used is to pick the material is based on the form of the material. The illustrative embodiments recognize and take into account that single dry fabric plies or prepreg plies can be picked and placed using electrostatic adhesion. The illustrative embodiments recognize and take into account that vacuum adhesion can undesirably cause deformation of the ply.

The illustrative embodiments recognize and take into account that vacuum adhesion can maintain a single ply in shape during picking and placing. The illustrative embodiments recognize and take into account that multiple plies that are consolidated prior to pick and best can be picked and placed using a vacuum end effector.

The illustrative embodiments recognize and take into account that changing between two different types of end effectors includes removing, replacing, and aligning entire end effectors and their frames. The illustrative embodiments recognize and take into account that removing and replacing different types of end effectors between pick and place operations can be undesirably time consuming. The illustrative embodiments recognize and take into account that storing two different kinds of end effectors can use an undesirable amount of manufacturing space, especially in space restricted environments. Using two different end effectors can instead use two separate mechanisms within the manufacturing environment for moving the end effectors, such as two industrial robots or two overhead gantries; this can be cost prohibitive.

The illustrative examples present one end effector that is capable of two types of adhesion for picking. The two different types of adhesion include vacuum suction and electrostatics. The illustrative examples allow for reduction of space and reduction of downtime due to elimination of changing two different types of end effectors. The illustrative examples provide one end effector with a switchable option to allow a vacuum end effector to be converted to an electrostatic end effector. The illustrative examples present an end effector that offers the ability to switch from vacuum based adhesion to electrostatic adhesion.

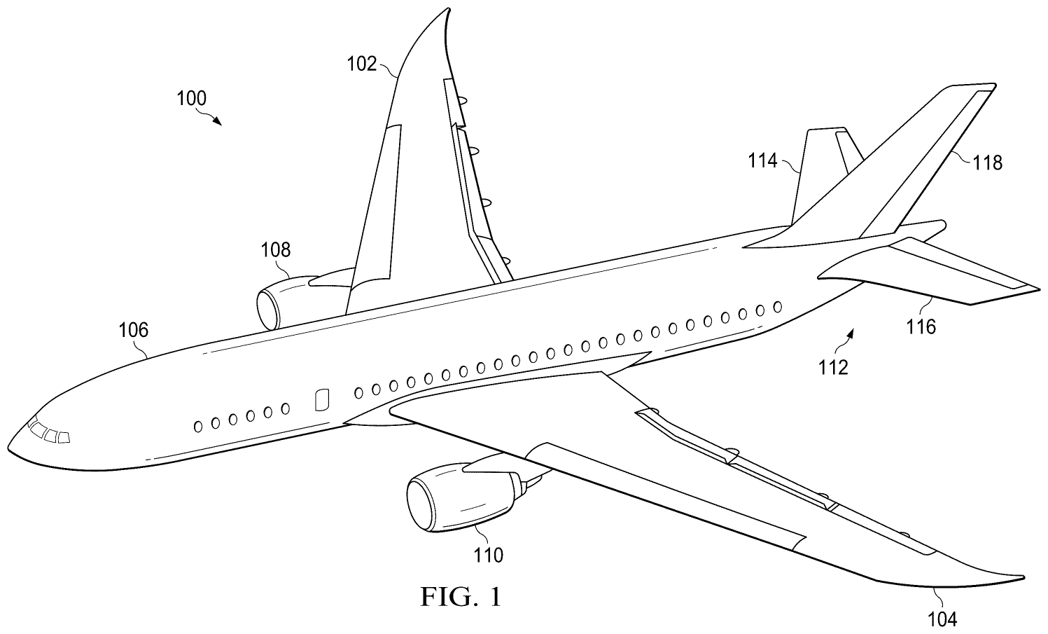

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite materials formed using a pick and place end effector configured to lift through two different mechanisms. In some illustrative examples, an electrostatic end effector comprising a vacuum end effector with a plurality of vacuum pogos and an electrostatic membrane configured to be removably held by the plurality of vacuum pogos can be used to pick and place composite material in manufacturing a component of aircraft 100.

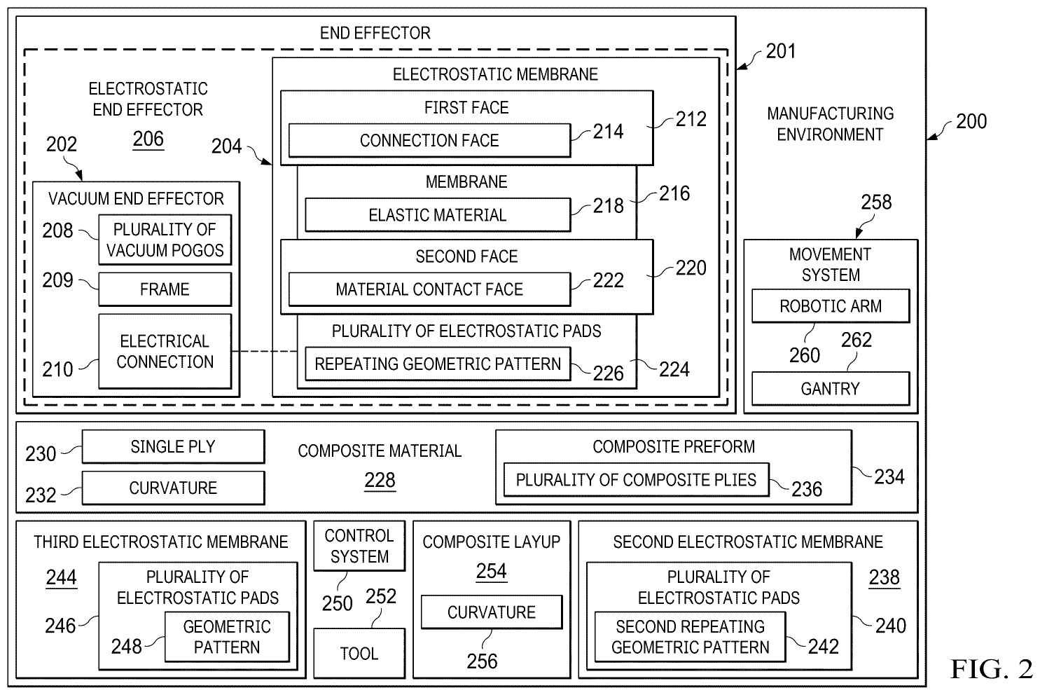

Turning now to FIG. 2, an illustration of a block diagram of a manufacturing environment is depicted in accordance with an illustrative embodiment. End effector 201 can be used to pick and place composite material of aircraft 100 during manufacturing of aircraft 100. End effector 201 is an end effector configured to lift composite material 228 through two different mechanisms. End effector 201 comprises vacuum end effector 202 with plurality of vacuum pogos 208 and electrostatic membrane 204 configured to be removably held by plurality of vacuum pogos 208. Plurality of vacuum pogos 208 is configured to pick and place composite preform 234 in contact with plurality of vacuum pogos 208. Electrostatic membrane 204 is configured to pick and place single ply 230 composite material 228 while electrostatic membrane 204 is held by plurality of vacuum pogos 208. When vacuum end effector 202 holds electrostatic membrane 204, end effector 201 takes the form of electrostatic end effector 206.

Composite preform 234 comprises plurality of composite plies 236. In some illustrative examples, composite preform 234 comprises plurality of composite plies 236 that is consolidated prior to pick and placing using vacuum end effector 202.

Each of plurality of vacuum pogos 208 is independently extendable relative to frame 209 of vacuum end effector 202. Each of plurality of vacuum pogos 208 is independently controllable to create a desired curvature. Each of plurality of vacuum pogos 208 is independently controllable to provide a vacuum to hold at least one of electrostatic membrane 204 or composite material 228 against plurality of vacuum pogos 208.

In some illustrative examples, plurality of vacuum pogos 208 maintain a consistent positioning relative to frame 209 during picking and placing of composite material 228. In some illustrative examples, plurality of vacuum pogos 208 will be moved relative to frame 209 to pick and place composite material 228 with a pre-existing curvature 232. In some illustrative examples, plurality of vacuum pogos 208 are maintained in a planar position to pick and place a planar composite material 228. In other illustrative examples, picking and placing composite material 228 includes placing curvature 232 into composite material 228. In these illustrative examples, at least one vacuum pogo of plurality of vacuum pogos 208 will move relative to frame 209 to introduce curvature 232 into composite material 228.

Electrostatic membrane 204 comprises first face 212 configured to be held by vacuum end effector 202 and second face 220 configured to contact composite material 228. First face 212 and second face 220 are opposite faces of electrostatic membrane 204. In some illustrative examples, first face 212 is referred to as connection face 214 as first face 212 connects electrostatic membrane 204 to vacuum end effector 202 to form electrostatic end effector 206. In some illustrative examples, second face 220 is referred to as material contact face 222 as second face 220 is in contact with composite material 228 during pick and place operations using electrostatics.

Electrostatic membrane 204 is held by plurality of vacuum pogos 208 when vacuum is provided through plurality of vacuum pogos 208. Plurality of vacuum pogos 208 interface with connection face 214. In some illustrative examples, connection face 214 is substantially smooth in locations to interface with plurality of vacuum pogos 208. In other illustrative examples, connection face 214 can include connection points to interface with plurality of vacuum pogos 208. In some illustrative examples, the connection points comprise mechanical connectors configured to connect to plurality of vacuum pogos 208.

Electrostatic membrane 204 comprises membrane 216 formed of elastic material 218 and plurality of electrostatic pads 224. Elastic material 218 is sufficiently flexible to form curvature 232 in composite material 228. Plurality of electrostatic pads 224 are configured to generate electrostatics to hold composite material 228 against electrostatic membrane 204.

Plurality of electrostatic pads 224 form part of material contact face 222 of elastic material 218. An opposite face of electrostatic membrane 204 is connection face 214 configured to be held by plurality of vacuum pogos 208.

Electrostatic membrane 204 is electrically connected to vacuum end effector 202 by electrical connection 210 to power electrostatic membrane 204. Electricity provided by electrical connection 210 is used by plurality of electrostatic pads 224 to generate electrostatics.

Plurality of electrostatic pads 224 is laid out to allow for forming curvature 232 in composite material 228 and electrostatic membrane 204. In some illustrative examples, plurality of electrostatic pads 224 is laid out in repeating geometric pattern 226. Different electrostatic pads can be used to form different curvatures into composite materials. Electrostatic membrane 204 can be exchanged with a different electrostatic membrane with a different pattern of electrostatic pads to form different curvatures. Vacuum end effector 202 is configured to utilize any desired electrostatic membrane.

In some illustrative examples, vacuum end effector 202 can removably hold second electrostatic membrane 238. In some illustrative examples, electrostatic membrane 204 can be removed and replaced with second electrostatic membrane 238 configured to be removably held by plurality of vacuum pogos 208. In some illustrative examples, second electrostatic membrane 238 comprises plurality of electrostatic pads 240 laid out in second repeating geometric pattern 242 different from repeating geometric pattern 226. Different electrostatic membranes can be used to pick and place different sizes or shapes of composite material 228. In some illustrative examples, different electrostatic membranes can be used to form different curvatures.

In some illustrative examples, third electrostatic membrane 244 can be removably held by plurality of vacuum pogos 208 of vacuum end effector 202. Third electrostatic membrane 244 comprises plurality of electrostatic pads 246 laid out in geometric pattern 248 different from second repeating geometric pattern 242 and repeating geometric pattern 226.

Electrostatic membrane 204 can be removed to use vacuum end effector 202 to pick and place composite material 228 using vacuum provided by plurality of vacuum pogos 208. Frame 209 of vacuum end effector 202 can remain connected to a respective robotic arm, gantry, or other movement system in manufacturing environment 200 while end effector 201 picks and places using either vacuum or electrostatics. In some illustrative examples, frame 209 of vacuum end effector 202 remains connected to movement system 258 while picking and placing using either vacuum or electrostatics. In some illustrative examples, frame 209 of vacuum end effector 202 remains connected to robotic arm 260 or gantry 262.

Electrostatic membrane 204 can be repeatedly held and released by vacuum end effector 202 as desired to form composite layup 254 on tool 252. In some illustrative examples, at least one layer of composite layup 254 can be picked and placed by vacuum end effector 202 using plurality of vacuum pogos 208. In some illustrative examples, at least one layer of composite layup 254 can be picked and placed by electrostatic end effector 206 using plurality of electrostatic membrane 204.

In some illustrative examples, electrostatic end effector 206 can be used to repeatedly pick and place single layers of composite material 228 to form a stack of composite plies. In some illustrative examples, after forming the stack of composite plies, electrostatic membrane 204 is released and vacuum end effector 202 is used to pick and place the stack of composite plies.

In some illustrative examples, composite layup 254 has curvature 256. In some illustrative examples, curvature 256 is formed in layers of composite layup 254 as each layer is applied to tool 252. In other illustrative examples, curvature 256 can be applied to layers of composite layup 254 prior to applying the respective layer to tool 252. In some illustrative examples, curvature 256 is applied to respective layers of composite layup 254 by applying pressure from at least one of vacuum end effector 202 or electrostatic membrane 204 to a forming tool.

Control system 250 is configured to selectively activate at least one of vacuum to plurality of vacuum pogos 208 or electricity to electrostatic membrane 204 of electrostatic end effector 206. In some illustrative examples, control system 250 is used to control holding or releasing electrostatic membrane 204 from vacuum end effector 202. In some illustrative examples, control system 250 is further configured to move plurality of vacuum pogos 208 to form curvature 232 in composite material 228.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, electrostatic membrane 204 and second electrostatic membrane 238 can be different from each other in ways in addition to the different geometric patterns. In some illustrative examples, at least one of a material or thickness of membrane 216 may be different than a membrane of second electrostatic membrane 238. In other illustrative examples, surface areas of electrostatic membrane 204 and second electrostatic membrane 238 are different. As another example, although not depicted, end effector 201 can comprise a slip element between vacuum end effector 202 and electrostatic membrane 204 to enable movement of plies for conforming into a complex shape.

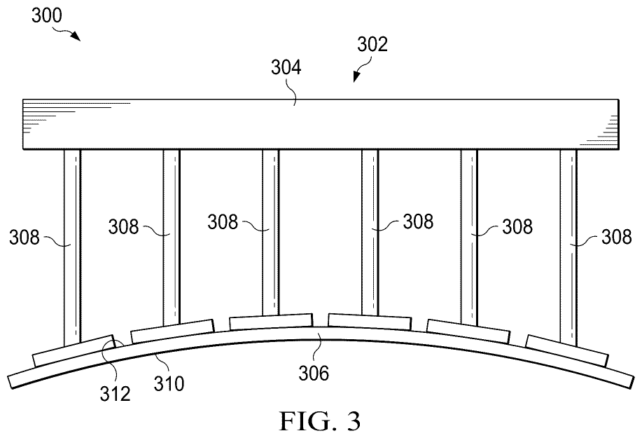

Turning now to FIG. 3, an illustration of a side view of an electrostatic end effector is depicted in accordance with an illustrative embodiment. Electrostatic end effector 300 is a physical implementation of electrostatic end effector 206. Electrostatic end effector 300 can be used to pick and place composite material of aircraft 100 during manufacturing of aircraft 100. Electrostatic end effector 300 is an end effector configured to lift composite material through two different mechanisms. Electrostatic end effector 300 comprises vacuum end effector 302 with plurality of vacuum pogos 308 and electrostatic membrane 306 configured to be removably held by plurality of vacuum pogos 308. Plurality of vacuum pogos 308 is configured to pick and place a composite preform in contact with plurality of vacuum pogos 308. Electrostatic membrane 306 is configured to pick and place a single ply composite material while electrostatic membrane 306 is held by plurality of vacuum pogos 308.

Each of plurality of vacuum pogos 308 is independently extendable relative to frame 304 of vacuum end effector 302. Each of plurality of vacuum pogos 308 is independently controllable to create a desired curvature. Each of plurality of vacuum pogos 308 is independently controllable to provide a vacuum to hold at least one of electrostatic membrane 306 or a composite material. Although depicted in a curvature, plurality of vacuum pogos 308 can be positioned to pick and place a planar composite material or any other shape of composite material.

Although not visible in FIG. 3, electrostatic membrane 306 is electrically connected to vacuum end effector 302 to power electrostatic membrane 306. Although not visible in FIG. 3, a control system configured to selectively activate at least one of vacuum to plurality of vacuum pogos 308 or electricity to electrostatic membrane 306 is connected to electrostatic end effector 300. Electrostatic membrane 306 comprises a membrane formed of an elastic material and a plurality of electrostatic pads (not depicted).

The plurality of electrostatic pads form part of material contact face 310 of the elastic material. An opposite face of the membrane is connection face 312 configured to be held by plurality of vacuum pogos 308. In some illustrative examples, the plurality of electrostatic pads are laid out in a repeating geometric pattern.

Electrostatic membrane 306 can be removed to use vacuum end effector 302 to pick and place a composite material using vacuum provided by plurality of vacuum pogos 308. In some illustrative examples, electrostatic membrane 306 can be removed and replaced with a second electrostatic membrane (not depicted) configured to be removably held by plurality of vacuum pogos 308. In some illustrative examples, the second electrostatic membrane comprises a plurality of electrostatic pads laid out in a second repeating geometric pattern different from the repeating geometric pattern. Different electrostatic membranes can be used to pick and place different sizes or shapes of composite materials. In some illustrative examples, different electrostatic membranes can be used to form different curvatures.

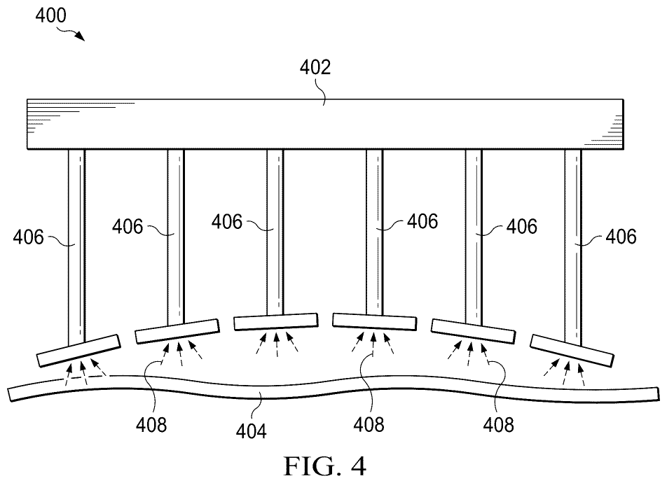

Turning now to FIG. 4, an illustration of a side view of a vacuum end effector pulling vacuum to connect an electrostatic membrane is depicted in accordance with an illustrative embodiment. Vacuum end effector 402 is a physical implementation of vacuum end effector 202 of FIG. 2. In some illustrative examples, vacuum end effector 402 is the same as vacuum end effector 302 of FIG. 3. In view 400, vacuum end effector 402 is not connected to or carrying electrostatic membrane 404. Electrostatic membrane 404 is a physical implementation of electrostatic membrane 204 of FIG. 2.

In view 400, vacuum 408 is provided to plurality of vacuum pogos 406 of vacuum end effector 402. Vacuum 408 can be used to hold electrostatic membrane 404 by vacuum end effector 402. When vacuum end effector 402 holds electrostatic membrane 404, vacuum end effector 402 and electrostatic membrane 404 form an electrostatic end effector that can pick and place composite material using electrostatics. When vacuum end effector 402 is separate from electrostatic membrane 404, vacuum end effector 402 can pick and place composite material using vacuum 408. Although depicted in a curvature, plurality of vacuum pogos 406 can be positioned to pick and place a planar composite material or any other shape of composite material. Plurality of vacuum pogos 406 can be moved before lifting a composite material, while lifting a composite material, or as the composite material is placed on a tool.

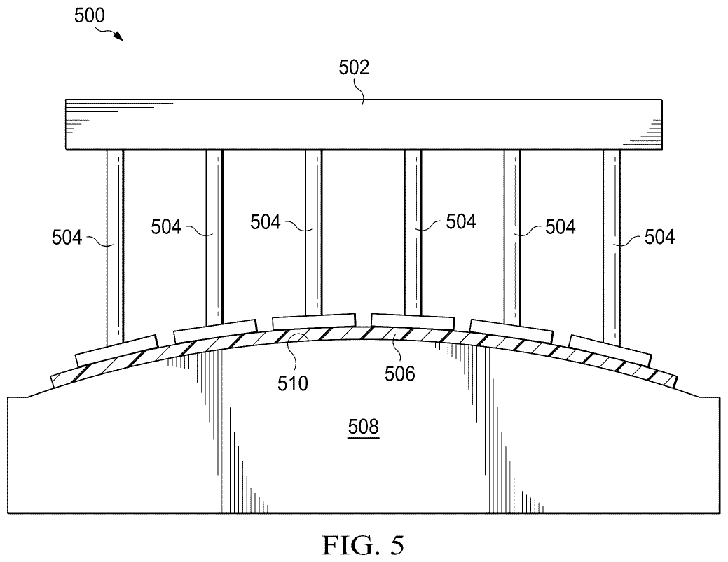

Turning now to FIG. 5, an illustration of a side view of a vacuum end effector picking and placing a composite preform is depicted in accordance with an illustrative embodiment. Vacuum end effector 502 is a physical implementation of vacuum end effector 202 of FIG. 2. In view 500, vacuum end effector 502 has picked and placed composite preform 506. In view 500, vacuum end effector 502 holds composite preform 506 against plurality of vacuum pogos 504. Vacuum (not depicted) is provided to plurality of vacuum pogos 504 to pick and place composite preform 506.

In this illustrative example, vacuum end effector 502 is used to form a curvature into composite preform 506. In other non-depicted examples, vacuum end effector 502 can be used to pick and place composite preform 506 or other composite material in a planar position. In other non-depicted examples, vacuum end effector 502 can be used to pick and place composite preform 506 or other composite material in a different curvature.

As depicted, vacuum end effector 502 is placing composite preform 506 against curved surface 510 of tool 508. Composite preform 506 comprises a plurality of composite plies. Composite preform 506 is thicker and more rigid than a single composite ply. Vacuum end effector 502 provides sufficient support to maintain a curvature in composite preform 506.

In some illustrative examples, a composite layup is formed on tool 508. In some illustrative examples, tool 508 is a layup tool that receives a plurality of composite layers. In other illustrative examples, tool 508 is a shaping tool. In some illustrative examples, vacuum end effector 502 forms a curvature in composite preform 506 prior to placing composite preform 506 against tool 508. In some illustrative examples, vacuum end effector 502 forms a curvature in composite preform 506 by moving plurality of vacuum pogos 504. In some illustrative examples, vacuum end effector 502 forms a curvature in composite preform 506 by pressing composite preform 506 against curved surface 510 of tool 508. In some illustrative examples, vacuum end effector 502 forms a curvature in composite preform 506 by pressing composite preform 506 against a shaping tool prior to placing composite preform 506 against tool 508.

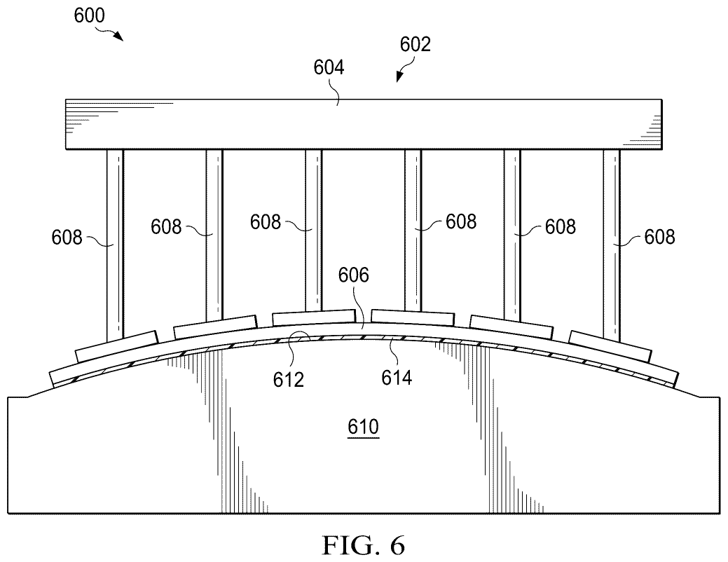

Turning now to FIG. 6, an illustration of a side view of an electrostatic end effector picking and placing a composite ply is depicted in accordance with an illustrative embodiment. Electrostatic end effector 602 is a physical implementation of electrostatic end effector 206 of FIG. 2. In view 600, electrostatic end effector 602 has picked and placed composite ply 614. Electrostatic end effector 602 is an end effector configured to lift composite material through two different mechanisms. Electrostatic end effector 602 comprises vacuum end effector 604 with plurality of vacuum pogos 608 and electrostatic membrane 606 configured to be removably held by plurality of vacuum pogos 608. In view 600, electrostatic end effector 602 holds composite ply 614 against electrostatic membrane 606 using electrostatics. Electricity is provided to electrostatic membrane 606 by vacuum end effector 604 to pick and place composite ply 614.

In this illustrative example, electrostatic end effector 602 is used to form a curvature into composite ply 614. In other non-depicted examples, electrostatic end effector 602 can be used to pick and place composite ply 614 in a planar position. In other non-depicted examples, electrostatic end effector 602 can be used to pick and place composite ply 614 in a different curvature.

As depicted, electrostatic end effector 602 is placing composite ply 614 against curved surface 612 of tool 610. Electrostatic end effector 602 provides sufficient support to maintain a curvature in composite ply 614.

In some illustrative examples, a composite layup is formed on tool 610. In some illustrative examples, tool 610 is a layup tool that receives a plurality of composite layers. In other illustrative examples, tool 610 is a shaping tool. In some illustrative examples, electrostatic end effector 602 forms a curvature in composite ply 614 prior to placing composite ply 614 against tool 610. In some illustrative examples, electrostatic end effector 602 forms a curvature in composite ply 614 by moving plurality of vacuum pogos 608. In some illustrative examples, electrostatic end effector 602 forms a curvature in composite ply 614 using vacuum end effector 604. Electrostatic end effector 602 can form a curvature in composite ply 614 using vacuum end effector 604 by vacuum end effector 604 pressing composite ply 614 against a curved surface. In some illustrative examples, electrostatic end effector 602 forms a curvature in composite ply 614 by pressing composite ply 614 against curved surface 612 of tool 610. In some illustrative examples, electrostatic end effector 602 forms a curvature in composite ply 614 by pressing composite ply 614 against a shaping tool prior to placing composite ply 614 against tool 610.

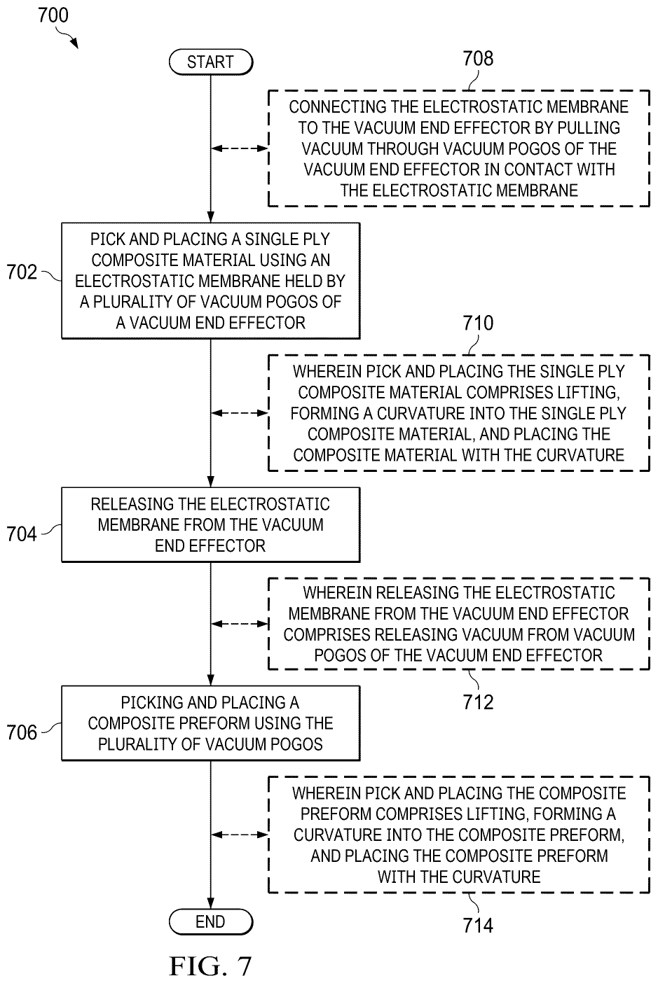

Turning now to FIG. 7, a flowchart of a method of picking and placing composite material using a single end effector with two different mechanisms is depicted in accordance with an illustrative embodiment. Method 700 can be used to manufacture a composite component of aircraft 100. Method 700 can be performed using vacuum end effector 202 and electrostatic membrane 204 of FIG. 2. Method 700 can be performed using vacuum end effector 302 and electrostatic membrane 306 of FIG. 3. Method 700 can be performed using vacuum end effector 402 and electrostatic membrane 404 of FIG. 4. Method 700 can be performed using vacuum end effector 502 of FIG. 5. Method 700 can be performed using vacuum end effector 604 and electrostatic membrane 606 of FIG. 6.

Method 700 pick and places a single ply composite material using an electrostatic membrane held by a plurality of vacuum pogos of a vacuum end effector (operation 702). The electrostatic membrane is held by vacuum provided the plurality of vacuum pogos of the vacuum end effector. While vacuum holds the electrostatic membrane, the end effector is an electrostatic end effector configured to pick and place composite material using electrostatics.

Method 700 releases the electrostatic membrane from the vacuum end effector (operation 704). After releasing the electrostatic membrane, the end effector is configured to pick and place composite material using vacuum. After releasing the electrostatic membrane, the end effector is a vacuum end effector.

Method 700 pick and places a composite preform using the plurality of vacuum pogos (operation 706). To pick and place the composite preform, vacuum is applied to the composite preform using vacuum supplied through the plurality of vacuum pogos. Afterwards, method 700 terminates.

In some illustrative examples, method 700 connects the electrostatic membrane to the vacuum end effector by pulling vacuum through a plurality of vacuum pogos of the vacuum end effector in contact with the electrostatic membrane (operation 708). In some illustrative examples, a connection surface of the electrostatic membrane is smooth to allow for the plurality of vacuum pogos to hold the electrostatic membrane. In some illustrative examples, the connection surface of the electrostatic membrane has mechanical connectors to connect to the plurality of vacuum pogos.

In some illustrative examples, pick and placing the single ply composite material comprises lifting, forming a curvature into the single ply composite material, and placing the composite material with the curvature (operation 710). In some illustrative examples, forming the curvature is performed by moving a plurality of vacuum pogos of the vacuum end effector. In some illustrative examples, forming the curvature is performed by pressing the single ply composite material against a shaping tool prior to placing the single ply composite material. In some illustrative examples, the single ply composite material is formed and placed onto a tool with a curved face to form the curvature in the single ply composite material as the single ply composite material is placed on the tool.

In some illustrative examples, releasing the electrostatic membrane from the vacuum end effector comprises releasing vacuum from a plurality of vacuum pogos of the vacuum end effector (operation 712). In some illustrative examples, air is sent through the plurality of vacuum pogos to push the electrostatic membrane away from the plurality of vacuum pogos.

In some illustrative examples, pick and placing the composite preform comprises lifting, forming a curvature into the composite preform, and placing the composite preform with the curvature (operation 714). In some illustrative examples, forming the curvature is performed by moving a plurality of vacuum pogos of the vacuum end effector. In some illustrative examples, forming the curvature is performed by pressing the composite preform against a shaping tool prior to placing the composite preform. In some illustrative examples, the composite preform is formed and placed onto a tool with a curved face to form the curvature in the composite preform as the composite preform is placed on the tool.

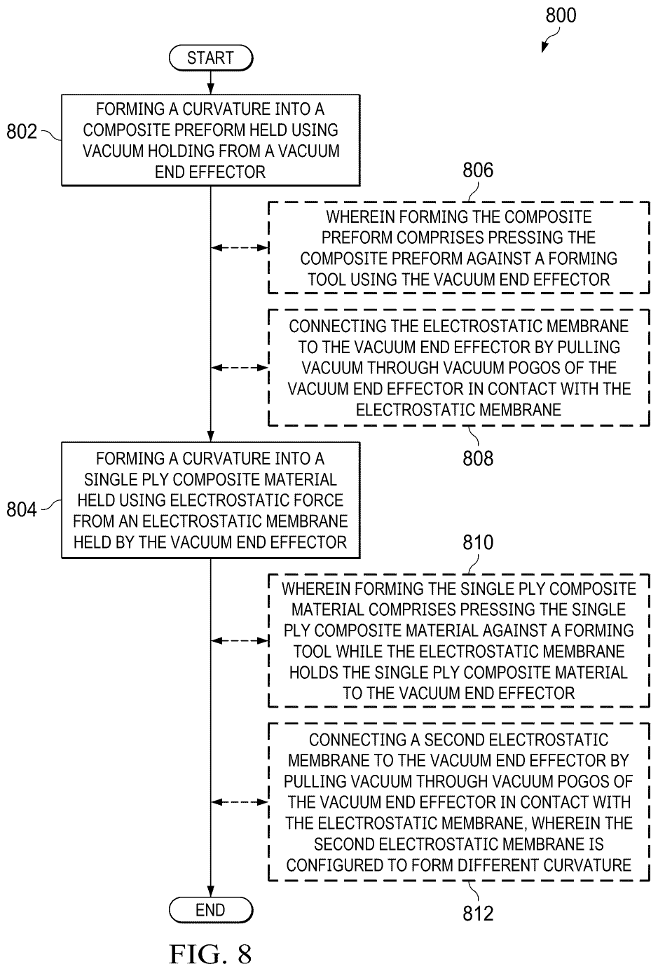

Turning now to FIG. 8, a flowchart of a method of picking and placing composite material using a single end effector with two different mechanisms is depicted in accordance with an illustrative embodiment. Method 800 can be used to manufacture a composite component of aircraft 100. Method 800 can be performed using vacuum end effector 202 and electrostatic membrane 204 of FIG. 2. Method 800 can be performed using vacuum end effector 302 and electrostatic membrane 306 of FIG. 3. Method 800 can be performed using vacuum end effector 402 and electrostatic membrane 404 of FIG. 4. Method 800 can be performed using vacuum end effector 502 of FIG. 5. Method 800 can be performed using vacuum end effector 604 and electrostatic membrane 606 of FIG. 6.

Method 800 forms a curvature into a composite preform held using vacuum holding from a vacuum end effector (operation 802). In some illustrative examples, forming the curvature is performed by moving a plurality of vacuum pogos of the vacuum end effector. In some illustrative examples, forming the curvature is performed by pressing the composite preform against a shaping tool prior to placing the composite preform. In some illustrative examples, the composite preform is formed and placed onto a tool with a curved face to form the curvature in the composite preform as the composite preform is placed on the tool.

Method 800 forms a curvature into a single ply composite material held using electrostatic force from an electrostatic membrane held by the vacuum end effector (operation 804). In some illustrative examples, forming the curvature is performed by moving a plurality of vacuum pogos of the vacuum end effector. In some illustrative examples, forming the curvature is performed by pressing the single ply composite material against a shaping tool prior to placing the single ply composite material. In some illustrative examples, the single ply composite material is formed and placed onto a tool with a curved face to form the curvature in the single ply composite material as the single ply composite material is placed on the tool. Afterwards, method 800 terminates.

In some illustrative examples, forming the composite preform comprises pressing the composite preform against a forming tool using the vacuum end effector (operation 806). In some illustrative examples, method 800 connects the electrostatic membrane to the vacuum end effector by pulling vacuum through vacuum pogos of the vacuum end effector in contact with the electrostatic membrane (operation 808).

In some illustrative examples, forming the single ply composite material comprises pressing the single ply composite material against a forming tool while the electrostatic membrane holds the single ply composite material to the vacuum end effector (operation 810). In some illustrative examples, method 800 connects a second electrostatic membrane to the vacuum end effector by pulling vacuum through vacuum pogos of the vacuum end effector in contact with the electrostatic membrane, wherein the second electrostatic membrane is configured to form different curvatures (operation 812).

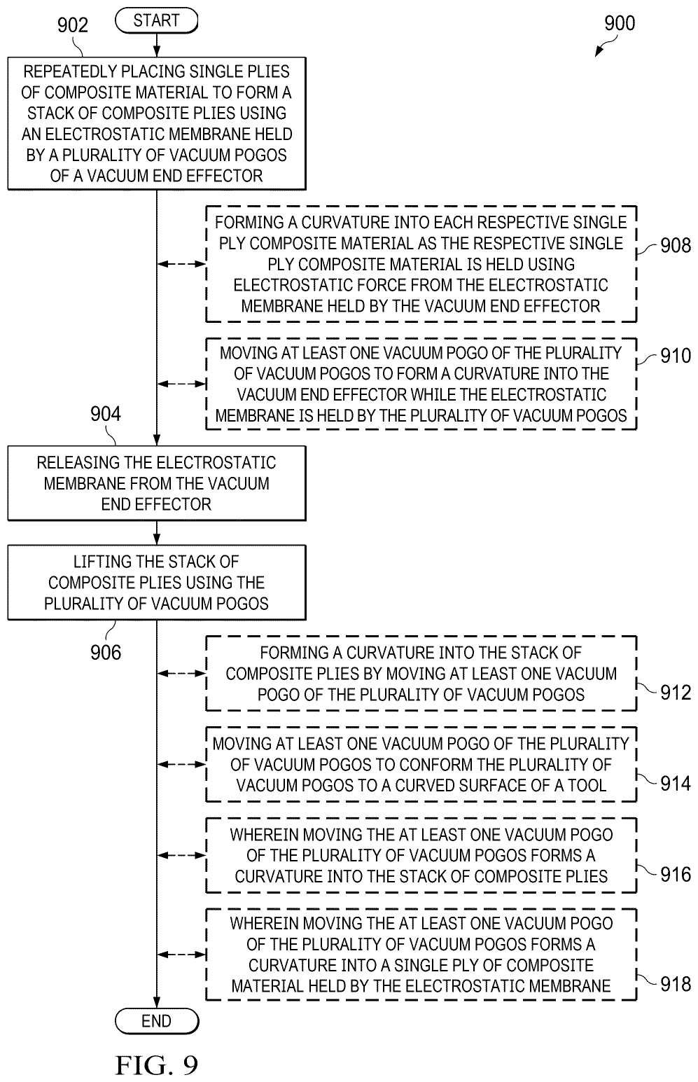

Turning now to FIG. 9, a flowchart of a method of picking and placing composite material using a single end effector with two different mechanisms is depicted in accordance with an illustrative embodiment. Method 900 can be used to manufacture a composite component of aircraft 100. Method 900 can be performed using vacuum end effector 202 and electrostatic membrane 204 of FIG. 2. Method 900 can be performed using vacuum end effector 302 and electrostatic membrane 306 of FIG. 3. Method 900 can be performed using vacuum end effector 402 and electrostatic membrane 404 of FIG. 4. Method 900 can be performed using vacuum end effector 502 of FIG. 5. Method 900 can be performed using vacuum end effector 604 and electrostatic membrane 606 of FIG. 6.

Method 900 repeatedly places single plies of composite material to form a stack of composite plies using an electrostatic membrane held by a plurality of vacuum pogos of a vacuum end effector (operation 902). Method 900 releases the electrostatic membrane from the vacuum end effector (operation 904). Method 900 lifts the stack of composite plies using the plurality of vacuum pogos (operation 906). Afterwards, method 900 terminates.

In some illustrative examples, method 900 forms a curvature into each respective single ply composite material as the respective single ply composite material is held using electrostatic force from the electrostatic membrane held by the vacuum end effector (operation 908). A curvature can be formed into each respective single ply composite material at least one of during lifting, against a shaping tool, or as the vacuum end effector and electrostatic membrane places the respective single ply.

In some illustrative examples, method 900 moves at least one vacuum pogo of the plurality of vacuum pogos to form a curvature into the vacuum end effector while the electrostatic membrane is held by the plurality of vacuum pogos (operation 910). In some illustrative examples, the curvature is formed into the vacuum end effector prior to lifting a respective single ply composite material. In some illustrative examples, the curvature is formed into the vacuum end effector during lifting a respective single ply composite material. In some illustrative examples, the curvature is formed into the vacuum end effector while placing a respective single ply composite material.

In some illustrative examples, method 900 forms a curvature into the stack of composite plies by moving at least one vacuum pogo of the plurality of vacuum pogos (operation 912). In some illustrative examples, the curvature is formed into the stack of composite plies during lifting the stack of composite plies. In some illustrative examples, the curvature is formed into the stack of composite plies while placing the stack of composite plies.

In some illustrative examples, method 900 moves

at least one vacuum pogo of the plurality of vacuum pogos to conform the plurality of vacuum pogos to a curved surface of a tool (operation 914). In some illustrative examples, the tool is a shaping tool for forming a curvature into a composite material prior to placing the composite material. In some illustrative examples, the tool is a layup tool with a curved surface configured to receive composite material.

In some illustrative examples, moving the at least one vacuum pogo of the plurality of vacuum pogos forms a curvature into the stack of composite plies (operation 916). In some illustrative examples, moving the at least one vacuum pogo of the plurality of vacuum pogos forms a curvature into a single ply of composite material held by the electrostatic membrane (operation 918).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 708 through operation 714 may be optional. As another example, operation 806 through operation 812 may be optional. As yet another example, operation 908 through operation 918 may be optional.

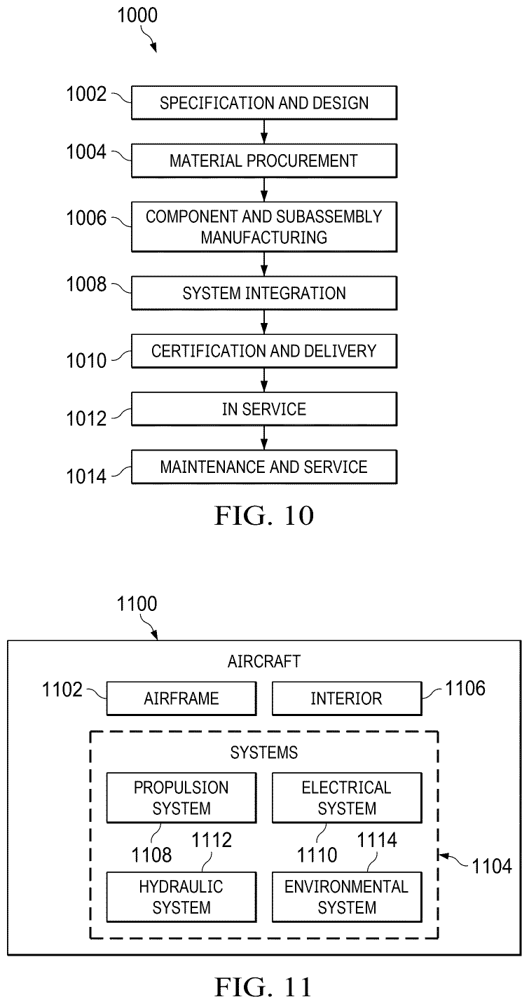

Illustrative embodiments of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method in a form of a block diagram is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 takes place. Thereafter, aircraft 1100 may go through certification and delivery 1010 in order to be placed in service 1012. While in service 1012 by a customer, aircraft 1100 is scheduled for routine maintenance and service 1014, which may include modification, reconfiguration, refurbishment, or other maintenance and service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of an aircraft in a form of a block diagram is depicted in which an illustrative embodiment may be implemented. In this example, aircraft 1100 is produced by aircraft manufacturing and service method 1000 of FIG. 10 and may include airframe 1102 with plurality of systems 1104 and interior 1106. Examples of systems 1104 include one or more of propulsion system 1108, electrical system 1110, hydraulic system 1112, and environmental system 1114. Any number of other systems may be included.

Apparatuses and methods embodied herein may be employed during at least one of the stages of aircraft manufacturing and service method 1000. One or more illustrative embodiments may be manufactured or used during at least one of component and subassembly manufacturing 1006, system integration 1008, in service 1012, or maintenance and service 1014 of FIG. 10.

The illustrative examples provide one end effector frame that can be used to provide two mechanisms for picking and placing composite material. The illustrative examples provide a vacuum end effector with vacuum suction cups located sporadically across that different pogos/actuators. A separate but removably connectable electrostatic membrane is provided. The electrostatic adhesion is provided as a separate part, the electrostatic membrane, that is picked up by the vacuum end effector. In some illustrative examples, electrical terminals are clipped in place to convert the pick surface of the end effector from vacuum to electrostatics.

In these illustrative examples, the end effector frame remains the same irrespective of the adhesion technology opted for in the pick and place process. An electrostatic membrane can be attached to an end effector using the vacuum cups of the vacuum end effector. The illustrative examples provide a dockable method to attach an electrostatic membrane to the end effector using vacuum cups. In the pick and place applications, the same end effector frame can be used with different electrostatic membranes. The shape and size of electrostatic pads can vary between electrostatic membranes. In some illustrative examples, the electrostatic pads take the form of triangles. The electrostatic pads can be tailored to the layup tool to receive composite material.

The illustrative examples provide a same end effector that can be used to pick and place using vacuum or pick and place using the electrostatic. The illustrative examples can reduce manufacturing downtime as there is no need to switch between two different end effectors for pick and place. In some illustrative examples, the electrostatic can be used primarily for single ply dry fabric pick and place and the vacuum can be used for ply stack up pick and place. This is “a pick and place” system combining both vacuum and electrostatic end effectors. The end effector comprises pogos to extend to conform to contour to be picked up. In some illustrative examples, an electrostatic membrane (ES) is vacuum adhered to the end effector. The end effector can be used to pick and place contoured single plies for pick and place. In some illustrative examples, the end effectors comprises a slip element between the vacuum and electrostatic end effector to enable movement of plies for conforming into a complex shape. Vacuum adhesion to the electrostatic membrane can be stopped and then vacuum adhesion at the end of the pogos would allow adhesion to consolidated/tacked (multi-ply) structure.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An end effector configured to lift composite material through two different mechanisms comprising:
a vacuum end effector with a plurality of vacuum pogos configured to pick and place a composite preform in contact with the plurality of vacuum pogos; and
an electrostatic membrane configured to be removably held by the plurality of vacuum pogos and pick and place a single ply composite material while the electrostatic membrane is held by the plurality of vacuum pogos.

2. The end effector of claim 1, wherein the electrostatic membrane is electrically connected to the vacuum end effector to power the electrostatic membrane.

3. The end effector of claim 1, further comprising:
a control system configured to selectively activate at least one of vacuum to the plurality of vacuum pogos or electricity to the electrostatic membrane.

4. The end effector of claim 1, wherein the electrostatic membrane comprises a membrane formed of an elastic material and a plurality of electrostatic pads.

5. The end effector of claim 4, wherein the plurality of electrostatic pads form part of a material contact face of the elastic material, and wherein an opposite face of the membrane is a connection face configured to be held by the plurality of vacuum pogos.

6. The end effector of claim 4, wherein the plurality of electrostatic pads are laid out in a repeating geometric pattern.

7. The end effector of claim 6 further comprising:
a second electrostatic membrane configured to be removably held by the plurality of vacuum pogos and pick and place a single ply composite material while the second electrostatic membrane is held by the plurality of vacuum pogos, wherein the second electrostatic membrane comprises a plurality of electrostatic pads laid out in a second repeating geometric pattern different from the repeating geometric pattern.

8. A method of picking and placing composite material using a single end effector with two different mechanisms comprising:
pick and placing a single ply composite material using an electrostatic membrane held by a plurality of vacuum pogos of a vacuum end effector;
releasing the electrostatic membrane from the vacuum end effector; and
picking and placing a composite preform using the plurality of vacuum pogos.

9. The method of claim 8, wherein pick and placing the single ply composite material comprises lifting, forming a curvature into the single ply composite material, and placing the composite material with the curvature.

10. The method of claim 8, wherein pick and placing the composite preform comprises lifting, forming a curvature into the composite preform, and placing the composite preform with the curvature.

11. The method of claim 8, wherein releasing the electrostatic membrane from the vacuum end effector comprises releasing vacuum from vacuum pogos of the vacuum end effector.

12. The method of claim 8 further comprising:
connecting the electrostatic membrane to the vacuum end effector by pulling vacuum through vacuum pogos of the vacuum end effector in contact with the electrostatic membrane.

13. A method of picking and placing composite material using a single end effector with two different mechanisms comprising:
forming a curvature into a composite preform held using vacuum holding from a vacuum end effector; and
forming a curvature into a single ply composite material held using electrostatic force from an electrostatic membrane held by the vacuum end effector.

14. The method of claim 13 further comprising:
connecting the electrostatic membrane to the vacuum end effector by pulling vacuum through vacuum pogos of the vacuum end effector in contact with the electrostatic membrane.

15. The method of claim 13, wherein forming the composite preform comprises pressing the composite preform against a forming tool using the vacuum end effector.

16. The method of claim 13, wherein forming the single ply composite material comprises pressing the single ply composite material against a forming tool while the electrostatic membrane holds the single ply composite material to the vacuum end effector.

17. The method of claim 13 further comprising:
connecting a second electrostatic membrane to the vacuum end effector by pulling vacuum through vacuum pogos of the vacuum end effector in contact with the electrostatic membrane, wherein the second electrostatic membrane is configured to form different curvature.

18. A method of picking and placing composite material using a single end effector with two different mechanisms comprising:
repeatedly placing single plies of composite material to form a stack of composite plies using an electrostatic membrane held by a plurality of vacuum pogos of a vacuum end effector;
releasing the electrostatic membrane from the vacuum end effector; and
lifting the stack of composite plies using the plurality of vacuum pogos.

19. The method of claim 18 further comprising:
forming a curvature into each respective single ply composite material as the respective single ply composite material is held using electrostatic force from the electrostatic membrane held by the vacuum end effector.

20. The method of claim 18 further comprising:
forming a curvature into the stack of composite plies by moving at least one vacuum pogo of the plurality of vacuum pogos.

21. The method of claim 18 further comprising:
moving at least one vacuum pogo of the plurality of vacuum pogos to form a curvature into the vacuum end effector while the electrostatic membrane is held by the plurality of vacuum pogos.

22. The method of claim 18 further comprising:
moving at least one vacuum pogo of the plurality of vacuum pogos to conform the plurality of vacuum pogos to a curved surface of a tool.

23. The method of claim 22, wherein moving the at least one vacuum pogo of the plurality of vacuum pogos forms a curvature into the stack of composite plies.

24. The method of claim 22, wherein moving the at least one vacuum pogo of the plurality of vacuum pogos forms a curvature into a single ply of composite material held by the electrostatic membrane.
